(19) United States
(12) Patent Application Publication
(10) Pub. No.: US 2009/0192998 A1
(43) Pub. Date: Jul. 30, 2009

(54) SYSTEM AND METHOD FOR DEDUCED META TAGS FOR ELECTRONIC MEDIA

(75) Inventor: Chett B. Paulsen, Sandy, UT (US)

Correspondence Address: THORPE NORTH & WESTERN, LLP., P.O. Box 1219, SANDY, UT, 84091-1219, US

(73) Assignee: AVINCI MEDIA, LC, Draper, UT (US)

(21) Appl. No.: 12/358,116

(22) Filed: Jan. 22, 2009

Related U.S. Application Data
(60) Provisional application No. 61/022,741, filed on Jan. 22, 2008.

(51) Int. Cl. G06F 17/30

(52) U.S. Cl. 707/3; 707/103 R; 707/E17.014; 707/E17.045

(57) ABSTRACT

A system and method is provided of creating meta tags for a multi-media object. The method can include the operation of choosing a template model that includes meta tags. The user can also select the multi-media object from an electronic storage device. Another operation is associating the multi-media object with the template model in response to a user's request. The meta tags from the template model can be assigned to the multi-media object stored on the electronic storage device.

### PRIORITY CLAIM

Priority of U.S. Provisional patent application Ser. No. 61/022,741 filed on Jan. 22, 2008 is claimed which is hereby incorporated herein by reference in its entirety.

### FIELD OF THE INVENTION

The present invention relates generally to electronic media.

### BACKGROUND

One of the many challenges facing the computer multimedia market today is the issue of providing search tools that can aid in searching vast stores of multimedia (digital images, video and audio). The photo imaging industry estimates that more than 200 billion digital images are captured annually with the number projected to rise to more than 1 trillion annually by 2012. In addition to still images, millions of hours of video are also being captured.

Multimedia is considered “rich” due to the large files and depth of information depicted, and there have been many approaches to try to help consumers to organize and/or search through their ever growing stores of multimedia files.

One common approach to searching is to allow users to apply tags or attributes to images, video clips and video. This includes well known tagging methods and visual “interrogation” methodologies.

Traditional tagging involves an automatic process where an electronic device populates certain pre-defined description fields, meta tags, or attribute values in order to describe the physical properties of the media. These tags may include information such as:

| Auto-generated reference name: | DCN1045678 |
|---|---|
| Description of physical properties | 1600 pixels by 1200 pixels |
| File size: | 1 Mbyte |
| Camera Name: | Nikon |
| Lens Type: | 55 mm |
| Aperature: | f8 |
| Date | 4/1/2000 |

Manual tagging has also taken a number of approaches. These include the use of predetermined “stamps” that users apply manually to images using a graphical interface. Stamps might include descriptions like:

Vacation

Family

Friends

Users can choose or create a stamp and then associate the stamp with an individual media object by either clicking on the media or dragging and dropping the stamp onto the media object. As a result, the media can be “marked” with an icon indicating the individual tags.

Manual tagging may also use manually entered “words” or “phrases” allowing users to attach text to the “properties” of the media. These text fields are typically chosen and entered by the end user. In order to search such manually entered phrases, the search terms need to be entered very accurately by the user to search for desired items in the media pool. Another difficulty with such user applied properties is the custom user tags are not typically known or even shared between users. User key words that are entered in the manual tagging method vary widely and might include varying terms such as: “Good Times”, “Never Forget”, “John's Parents” and other terms which are difficult for others to guess or even reproduce. An example of this type of tagging may be the web site and applications provided the company Flickr.

In present searching systems, the search terms are searched on the basis that the search term either exists in the target data or the search term does not exist in the target data. For example, a typical search for the word “vacation” in the properties or meta tags for media files will return the search results for only those media objects with the exact word “vacation” referenced in the meta file. Even when searching using wildcards, the exact term used in the root of the expansion needs to exist in a meta tag to generate a match. For example, “vacation*” still needs to find the word vacation to get a match.

Some systems have tried to apply automatic organization strategies. However, such efforts have currently been limited to chronologically oriented methods using meta tags assigned by the device, whether camera or scanner. The storage systems can look at this time stamped digital data, and then organize the information according to the time stamp. While this provides some organization, the date information provides little context for the contents of the multi-media object. One key fault lies in its reliance on chronology. For example, if you were born in 1956 and scanned a baby picture into a digital file in 2006, this type of organization would file your baby picture in a folder titled “2006”.

Other automation technologies attempt to use facial recognition or scene recognition in order to automatically reference media according to subject of the media. While automatic, these technologies attempt to identify the “who” but cannot provide any other significant information.

Most of the current industry practices for meta tagging attempt to simulate paper filing systems and use well known paper style filing methodologies to organize and retrieve media. In order to “search” media, you must first “organize” data. This means that an individual who wants to be able to search their multi-media archives needs to spend a large amount of time tagging and organizing those files. As would be expected in today's busy world, there are very few individuals who are willing to take the time to attach tags to media or otherwise organize media folders. As a result, pictures, video, and audio are just dumped in unorganized directories and anyone who wants to search through them does so in the same fashion that the user would search through unorganized paper archives, which is in an item by item fashion.

### SUMMARY OF THE INVENTION

A system and method is provided of creating meta tags for a multi-media object. The method can include the operation of choosing a template model that includes meta tags via a user's interaction. The user can select the multi-media object from an electronic storage device. Another operation is associating the template model with the multi-media object in response to a user's request. The meta tags from the template model can be assigned to the multi-media object stored on the electronic storage device.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 illustrates a window with the operating system's auto generated meta data for an image for use with an embodiment of the invention;

FIG. 2 illustrates meta data for an image which may be added by a digital camera for use with an embodiment of the invention;

FIG. 3 illustrates the meta tags that can be associated with a template in an embodiment of the invention;

FIG. 4 illustrates an enlarged partial view of the template of FIG. 3;

FIG. 5 is a block diagram illustrating a system for creating meta tags for multi-media objects; and

FIG. 6 is a flow chart illustrating a method of creating meta tags for a media object.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

The present system and method includes an embodiment to assign meta tags to multimedia by recording what users do “in context” to their image and this produces new meta tags. In addition, the present system and method offers an approach to “predictive” searching that references media use and predicts meta tags for media which have not actually been tagged by the user. In other words, meta tags can be deduced by enjoyable play and unrelated work involving prepared multi-media templates for media.

An embodiment of the present system involves auto-generated, searchable meta tags derived from play and/or simple use behaviors using pre-tagged visual models, themes, backgrounds, templates, border, styles. In addition, meta tags can be applied based on use behaviors and a predictability algorithm. This allows the system to infer like meta tags to media that have a multi-dimensional proximity to the original media.

One aspect of this strategy is to record the “context” in which users use or play with their media objects that are stored on various electronic storage devices. The media objects or user media types can include digital images (still and animated), video, audio and text. As technology advances, other types of media objects experienced through other sensory perceptions, such as touch may become common and used by users. As the system and method herein involves assigning meta tags to multimedia objects, one skilled in the art will recognize the applicability of the system and method described herein to all kinds of multimedia objects.

In order to capture context, the object into which the user places their media will have definite searchable meta tags that are associated with the object. These meta tags may be contained in the same file or in an associated database, file, etc.

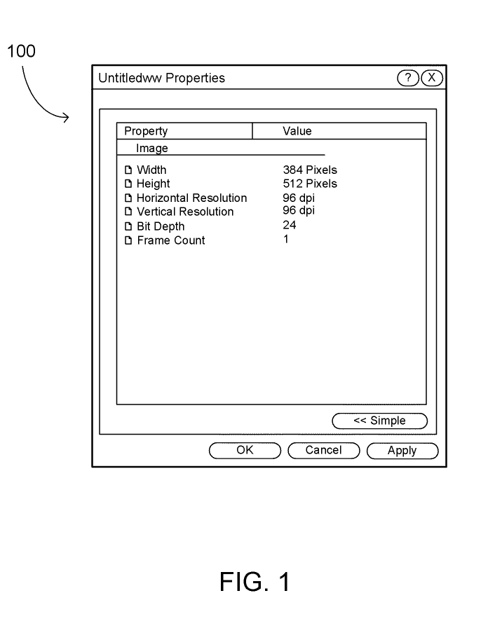

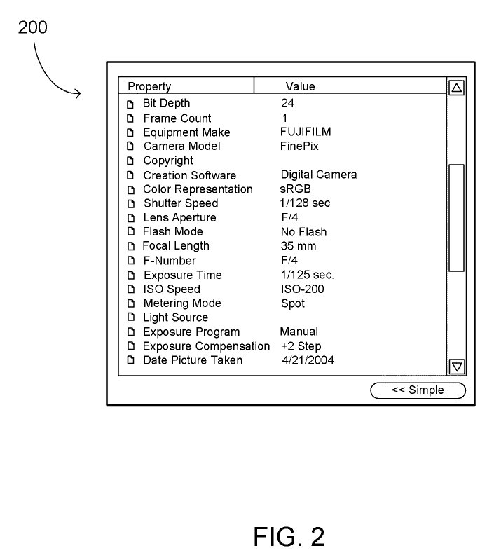

For example, user media, such as a photo or video, may have auto generated camera data. The operating system's auto generated meta data 100 for an image is shown in FIG. 1. Additional data 200 may be added by the camera as shown in FIG. 2. Note that none of the data relates to “contextual” data or conventional tags that could be used by consumers. More useful tags might include:
Best Friends
Sisters

An embodiment of the present system and method anticipates that most users “contextualize” their images by printing and sharing images, putting images into photo books or scrapbooks, and gifting items and streaming them via the web, or attaching them to email as well as other options for viewing and sharing media objects.

Most of these activities include putting the images into “context”. Traditionally, this contextualizing can include an email that reads “Hey great party” or “We're best Friends”.

The system can use pre-designed, meta tagged multimedia templates to help consumers put the media into context. Templates can include movies, slideshows, DVDs, photo books, scrapbooks, posters, streaming productions, greeting cards and many other sharing platforms. The template or template model may be any type of template desired by a user. Some anticipated template models include visual models, visual themes, styles, and backgrounds. Such templates can include pre-defined meta tags. In one aspect, the system and method may simply assign all of the pre-defined meta tags included with a template to a multimedia object for contextualization. In another aspect, the system and method may copy or assign one or more of the pre-defined meta tags to the multimedia object in response to editing or other actions taken by the user on the template model. The meta tags of this later embodiment may be determined solely based on user interaction with the template model, or may be determined while a user interacts with the template model in connection with the multimedia object. A user may also modify, add, or remove any meta tags associated with the template or the multimedia object, whether the meta tags are predefined or not. The modification, addition, or removal of meta tags can occur before, during, or after a user otherwise interacts with a multimedia object or template.

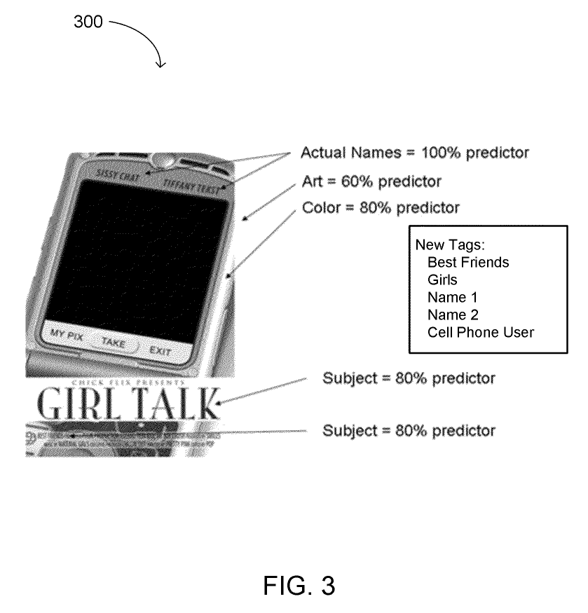

The system and method can use templates as exemplified in FIG. 3 to contextualize user experiences. The template 300 has numerous meta tags. The meta tags can be representative of design attributes of the template, or template model. In one aspect, the design attributes can be sensory attributes of the template, such as visual or audio attributes. For example, a template including picture of a black phone may have the meta tags “phone” or “black”. Some tags are more predictable than others. For example, if the user entered their own name, then the actual name is attached as a tag. Simply adding a tag is not unusual. However, the assignment of additional tags to the images being applied to the templates, including the “predictor” tags, provides a powerful tool for generating meta tags that are associated with the media objects.

Assigning meta tags to the multimedia object can provide the user with useful data regarding attributes, such as visual or audio attributes of the multimedia object. These meta tags can be viewable by the user in a similar manner as the meta tags shown in FIGS. 1 and 2 are viewable. Thus, a user can have a visual representation or listing of what meta tag associations have been created with the multimedia object.

As an example of predictively generating meta tags, new tags associated with an image inserted into the template 300 for FIG. 3 would likely be:

| Tag | Meta Driver |
|---|---|
| Female | Title “Girl Talk” |
| Friends | Subject “Best Friends” |
| Female | Color “pink” |
| Cellphone user | Stock Art “cellphone” |

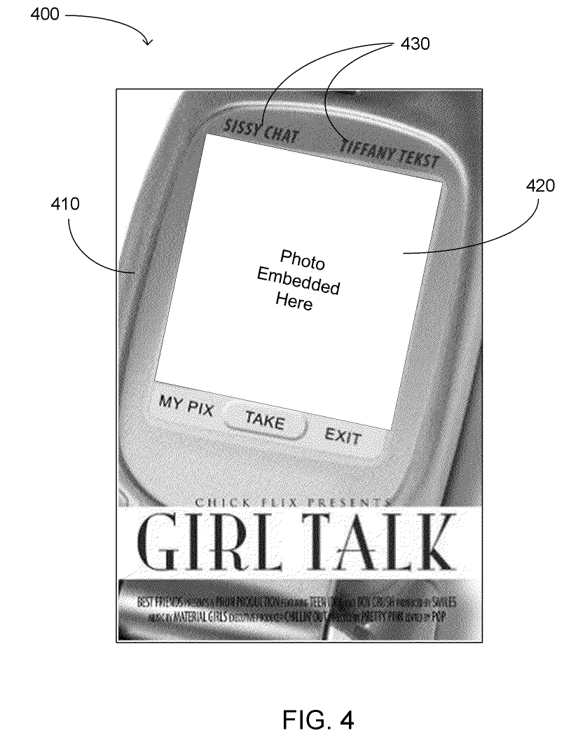

The combination of the image plus the template in FIG. 3 results in the composite image 400 in FIG. 4 with new meta tags. As also in FIG. 3, FIG. 4 shows the composite image which has been created from a template 410 having a cell phone. A photo 420 can be inserted into the template. Other text 430 and design elements can be added as well to create the composite image. The tags shown in FIG. 3 and discussed above are generated from various sources. For instance, the phone template may have meta tags for a phone and the color of the phone. The system and method can also use other design elements such as the names and other text and design elements inserted into the template to form other of the tags listed. One or more of these tags can then be assigned to the multimedia object, which is in this case is a photo. The tags may also be assigned to the composite image.

Any multimedia object associated with a template may form a composite multimedia object to which meta tags may be assigned, and which may be selectively stored on an electronic storage device. In another aspect, a combination of a multimedia object with a template may form a customized template. This customized template may be the end product of the user's interaction, or may be further used as a template for use in another project or user interaction. Additionally, meta tags assigned to the composite multimedia object or to the customized template may also be assigned to the original multimedia object.

For example, the new meta tags that may be applied to the original media object and/or the composite image can include:

| Meta Tag | Probability |
|---|---|
| Friends | 80% |
| Female | 80% |
| Young | 80% |
| Sissy | 100% |
| Tiffany | 100% |
| Cellphone User | 60% |

These example tags have variable degrees of “predictability.” The predictability represents an estimated accuracy of the meta tags applied to the media object. While most of the meta tags are “likely”, the tags are not “Definite”. In contrast, the “Names” are definite and have a ranking of 100% because the user entered the names.

As a result of the probability rankings, or predictability values, it is valuable to offer users more than the traditional “On/Off” choices for searching and filtering. Accordingly, an embodiment of the invention can include a user determined filter that provides a drop down list or pick box with the following choices:

| | |
|---|---|
| Definite | 100% |
| Highly Likely | 66% to 99% |
| Likely | 33% to 65% |
| Somewhat Likely | 01% to 32% |
| No Match | 0% |

A search filter with the terms illustrated above can be part of a file open interface window, a file manager, a search engine, or another search application that can search through the media files. This additional search criteria is likely to narrow the user's visual search by including more “potential” matches than traditional methods. Also, a predictability value may increase when a user selects a multimedia object after searching, sorting, or otherwise organizing multimedia objects via meta tags. In another aspect, when a user performs a search for a multimedia object not having a meta tag, predictive or not, matching the search term(s) and the user selects a multimedia object, the search term(s) can then be associated with the multimedia object as new meta tags.

As users progress from “preview” only application functions to “edit” functions and finally “make product” functions, the predictability of the tags can increase accordingly. In other words, the application tool that is used to composite the user selected media object together with a template (or other selected custom operation) progresses thorough certain creation stages. As a user passes through the creation stages, then the predictability for the tags may be increased. The inclusion of “inferred” meta tags aids in the user's search effort of the media objects.

In one example embodiment, suppose that a user captures a group of multimedia objects, such as images, sequentially numbered “01” to “99”. Further, assume that the user places image “88” in a vacation template titled “New York” and image “22” in a vacation template titled “San Francisco.”

Based on the proximity of the image in the number sequence and referencing the image capture date, it would be possible to assign a degree of “probability” that image number “87” is more likely an image from “New York” than it is of San Francisco. Likewise, image number “21” is more likely of San Francisco. As media loses its “proximity” the defined probability that the image matches the meta tag decreases. For example, while image “87” might be “Highly Likely” as match for “New York”, image “99” might only be “Somewhat Likely” as a match for “New York”.

Based on the use of images “88” and “22”, it is possible to “infer” with some probability that the images in the set (allowing that they have similar or approximate dates) are also definitely, highly likely, Likely or No Match to Play determined meta tags. Groupings of multimedia objects can be by time or event. In one aspect, the time is determined by the device which created the multimedia object (e.g., a capture time). In another aspect, the time may be determined by when the multimedia objects were stored on the electronic storage device. Likewise, an event grouping can happen by the event of multimedia objects being stored together on an electronic storage device, or as determined by the device which created the multimedia object (which may be able to determine events through user interaction). Predictability values may be assigned in progressively decreasing values as multimedia objects increase in time difference interval from a multimedia object to which meta tags have been assigned through the system and method herein. Likewise, predictability values may be assigned in progressively decreasing values as the multimedia object increases in organizational distance away from a multimedia object to which meta tags have been assigned through this system and method.

A benefit to this strategy is that users who are prone to dislike organizational activities and housekeeping, may choose search filter options that show more images. Note that all of the additional tagging is done automatically by the software system and does not typically require the user to type key words or manually “stamp” tags. All tagging is the result of simply using the images or applying multimedia templates which have meta tagged. In other terms, as users “play” with multi-media templates, the meta tagging work is done automatically without any intentional work on the user's part.

The assignment of the meta tags also provides data that enables multi-media objects to be searched using the assigned probabilities. For example, a narrow search on “Vacation” with the “Definite” filter might yield two (2) images. The same search with the “Highly Likely” filter might yield ten (10) matches and a “Likely” tag one hundred (100). In all cases, the search is more valuable to the user because the “inclusion” factor is more valuable than the “exclusion” model.

In addition, drop down menus may provide an extensive list of searchable terms that were generated by the software automatically, and those tags may be physically attached to the media by the user.

The present system and method, meta tags are automatically added as users play with their media by creating useful, contextual products. The play is primarily “visual” as user can select the “look and feel” they want to be combined with the user objects or their own media objects.

The “play generated tags” are used to infer meta information and meta tags about other media that has some sort of “proximity” to media that has been put into context. Progressing from “preview” to “edit” to “make product” in the software that enables users to access templates increases the probability of the usefulness of the meta tags.

Search functions can be selectively chosen by the user to reflect “highly inclusive” versus “high exclusive” results. Choices may include “Definite”, “Highly Likely”, “Likely”, “Somewhat Likely” and “No Match”.

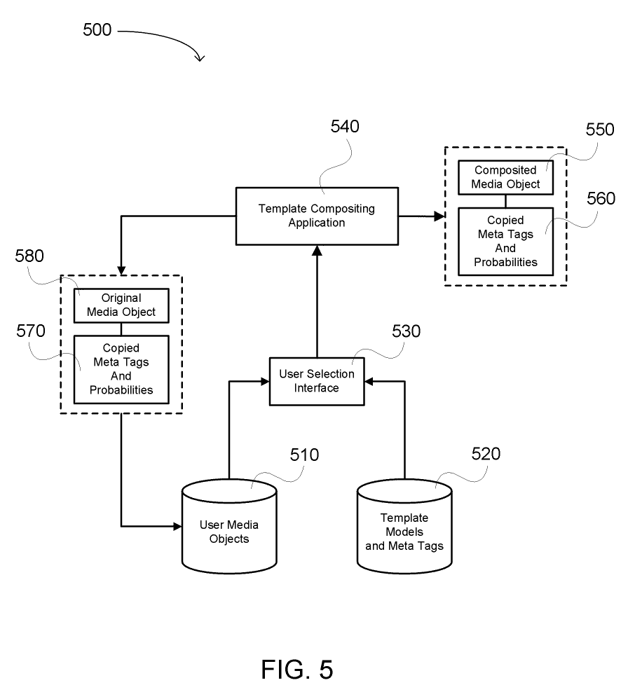

FIG. 5 is a block diagram illustrating an embodiment of a system 500 for creating meta tags for a multi-media object. User media objects 510 and template models with meta tags 520 are provided. Through a user selection interface 530 a user can select a media object and a template model. Using a template compositing application 540, the user can then combine the media object and the template model to create a composite media object 550. The composite media object can then have one or more meta tags copied 560 from the original template model. Each of these assigned meta tags can be given a probability or predictability value representing how closely associated the composite media object is with the meta tag, as described above. In like manner, similar meta tags and probabilities may be copied 570 or assigned to the original media object 580.

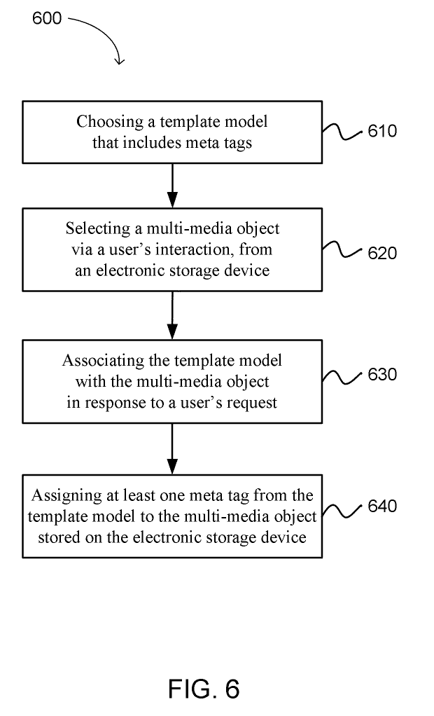

FIG. 6 is a flow chart illustrating an embodiment of a method 700 of creating meta tags for a media object. The method includes the step 710 of choosing a template model that includes meta tags representative of design attributes of the template model. Another step 720 is selecting the multi-media object via a user's interaction, from an electronic storage device. In a further step 730, the multi-media object is associated with the template model in response to a user's request. In a final step at least one meta tag from the template model is assigned to the multi-media object stored on the electronic storage device.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth herein.

1. A method of creating meta tags for a multi-media object, comprising:
choosing a template model that includes meta tags representative of design attributes of the template model;
selecting the multi-media object via a user's interaction, from an electronic storage device;
associating the multi-media object with the template model in response to a user's request; and
assigning at least one meta tag from the template model to the multi-media object stored on the electronic storage device.

2. A method as in claim 1, wherein the step of associating the multi-media object with the template model further comprises the step of combining the multimedia object and the template model together to form a composite multi-media object to which the meta tags are assigned.

3. A method as in claim 1, wherein the step of enabling the user to choose a template model with meta tags further comprises the step of choosing a template model including a plurality of pre-defined meta tags.

4. A method as in claim 3, further comprising the step of copying the pre-defined meta tags from the template model to the multi-media object in response to actions taken by the user on the template model.

5. A method as in claim 1, wherein the step of enabling the user to choose a template model that includes meta tags further comprises the step of choosing a template model including a plurality of meta tags modified by end users.

6. A method as in claim 1, wherein the step of enabling a user to choose a template model further comprises the step of enabling a user to choose a template model from the group consisting of visual models, visual themes, styles, backgrounds, and templates.

7. A method as in claim 1, wherein the step of selecting a multi-media object further comprises the step of selecting a multi-media object from the group consisting of: still pictures, animation, video, or audio.

8. A method as in claim 1, further comprising the step of assigning a predictability value to the multi-media object.

9. A method as in claim 8, further comprising the step of searching the multi-media object using the predictability value.

10. A method as in claim 1, wherein the design attributes include at least one of visual and audio attributes of elements of the template model.

11. A method of creating meta tags for media objects, comprising:
choosing a template model that includes pre-defined meta tags representative of design attributes of the template model;
selecting the media object via a user's interaction, from an electronic storage device;
applying the media object to the template model in response to the user's request to combine the media object and the template model to form a customized template; and
assigning at least one pre-defined meta tag from the template model to the customized template along with a predictability value representative of how closely the customized template is likely related to the at least one predefined meta tag.

12. A method as in claim 11, further comprising the step of assigning a predictability value that is a percentage.

13. A method as in claim 11, further comprising the step of applying a logical search to the meta tags of the customized template by searching for meta tags using search terms where the predictability value is above a user determined threshold.

14. A method as in claim 11, wherein the predictability value represents an estimated accuracy of the meta tags applied to the media object.

15. A method as in claim 11, further comprising the step of assigning meta tags to the customized template based on user interaction with the customized template.

16. A method of creating meta tags for a media object, comprising:
choosing a template model that includes template meta tags representative of design attributes of the template model;
selecting the media object via user interaction from a grouping of related multi-media objects on an electronic storage device;
applying the media object to the template model in response to the user's request to combine the media object and the template model;
assigning the template meta tags from the template model to the media object along with a predictability value; and
assigning the defined meta tags along with predictability values to grouped multi-media objects stored on the electronic storage device.

17. A method as in claim 15, wherein the grouping of related multi-media objects is by time or event.

18. A method as in claim 15, wherein the group of related multi-media objects is a stream of still photos that are marked based on a capture time.

19. A method as in claim 17, further comprising the step of assigning progressively decreasing predictability values as the still photos increase in time difference interval from the user's selected still photo.

20. A method as in claim 17, further comprising the step of assigning progressively decreasing predictability values as the still photos increase in organizational distance away from the user's selected still photo.
